(19) United States
(12) Patent Application Publication
(10) Pub. No.: US 2025/0115467 A1
(43) Pub. Date: Apr. 10, 2025

(54) Treatment System for Kegs

(71) Applicant: KHS GmbH, Dortmund (DE)

(72) Inventors: Volker Damerow, Uelversheim (DE); Sebastian Eckes, Langenlonsheim (DE); Maximilian Weindorf, Münsterappel (DE); Christian Pedersen, Kriftel (DE); Manfred Wahi, Oberwiesen (DE); Andreas Weber, Bad Sobernheim (DE); Olaf Muszinski, Bad Soden (DE)

(21) Appl. No.: 18/293,126

(22) PCT Filed: Aug. 30, 2022
(86) PCT No.: PCT/EP2022/073996

§ 371 Date: Jan. 29, 2024

(30) Foreign Application Priority Data
Aug. 31, 2021 (DE) 10 2021 122 435.7

(51) Int. Cl. B67C 3/26; B67C 3/00; B67C 3/30; B67C 7/00

(52) U.S. Cl. CPC B67C 3/2642; B67C 3/007; B67C 3/30; B67C 7/0053; B67C 7/0073

(57) ABSTRACT

The invention relates to a system (10) for treating kegs (12), comprising: at least two treatment modules (14a-14g), each of which has—a keg receiving area (35) for receiving at least one keg (12) during the treatment process, —a treatment head (36) for treating the keg (12), and—at least one interface (41) for a discharge and for at least one cleaning medium line and/or for at least one filling product line; and a controller (30) for controlling the treatment modules (14a-14g), wherein at least one of the treatment modules (14a-14g) is designed to treat kegs (12) of a first type and/or of a first size, and at least one other treatment module of the treatment modules (14a-14g) is designed to treat kegs (12) of a second type and/or of a second size.

### RELATED APPLICATIONS

This is the national stage of international application PCT/EP2022/073996, filed on Aug. 30, 2022, which claims the benefit of the Aug. 31, 2021 priority date of German application 10-2021-122-435.7, both of which are herein incorporated by reference.

### FIELD OF INVENTION

The present invention relates to a system for treating kegs, in particular for cleaning and/or filling kegs.

### BACKGROUND

In the early years of the beverage industry, selection was limited. As a result, it was usual to package large quantities of a single beverage. As a result, most kegs were of the same type with the same fittings. This was highly conducive to mass production.

In recent years, as selections have increased, it has become necessary to package smaller amounts, sometimes with different types of kegs and different keg sizes. For example, among breweries, particularly craft breweries, it has become common to brew different types of beer with different ingredients, sometimes with different fruit admixtures. Within the soft-drink industry, it has become common to package smaller quantities using different sweeteners, both natural and artificial.

To accommodate these changes, it has become common to reconfigure treatment-and-filling systems to handle different kegs. Thus, when a different species of beverage is to be bottled, a great deal of labor has to be carried out to prepare the treatment-and-filling system to accommodate a new type of keg.

### SUMMARY

An object of the invention that of providing a container treatment system that, with low expenditure, allows for the treatment of kegs of different types and/or sizes.

According to the invention, the system for the treatment of kegs comprises at least two treatment modules, each of which comprises a keg receiver for receiving at least one keg during the treatment, e.g. during the cleaning and/or filling. In addition, the treatment modules have a treatment head for the treating the kegs. The treatment head can be configured, for example, for the interior cleaning or for filling the keg. Preferably, the head is configured both for the interior cleaning as well as for filling the keg, which increases the flexibility of the system. Each treatment module additionally contains at least one interface for a discharge as well as for at least one cleaning medium line and/or for at least one filling product line. Moreover, the treatment system comprises a controller for controlling the treatment modules. According to the invention, at least one first treatment module is configured to treat kegs of a first type and/or of a first size, and at least one second treatment module is configured to treat kegs of a second type and/or a second size. Kegs can therefore differ from one another, for example, in respect of their fittings, their height, their material, their diameter, and/or their volume. All different keg types/sizes can be treated by different treatment modules.

It is therefore possible, without changing the treatment head of a treatment module, for kegs of different types and/or sizes to be treated simultaneously, without any conversion measures being required for the treatment modules. Such a system also complies with today's trend in the beverage industry, the aim of which is greater diversification of beverages, but also smaller filling quantities. Moreover, there is no need for different treatment systems for different kegs. The allocation of the kegs is carried out by the controller. Kegs may differ, for example, in their shape, in their material, in their filling volume, and also in their fittings for the connection to the treatment heads and to the different tapping systems of the end user. The invention therefore increases the flexibility of the system.

For the allocation of the different treatment modules to different keg types/sizes, account is preferably taken of the proportion of the total turnover. It is possible for more than two different keg types/sizes to be treated in one system according to the number of treatment modules.

A “filling product” in the meaning of the present invention can be, for example, a beverage, in particular a beverage containing CO2. For example, the filling product can be beer, a beer mixed drink, of a carbonated soft drink.

As “cleaning medium,” all the media come into consideration which are conventionally known to the person skilled in the art and used in the sector of the foodstuffs industry, in particular the beverage industry, usually in connection with cleaning. The cleaning may comprise several cleaning steps with different cleaning media, wherein the several cleaning steps can be carried out, for example, sequentially or one after another. Preferably, during the cleaning of the kegs, at least one alkali is used as the cleaning medium or as a constituent part of a cleaning medium.

Preferably, at least one of the treatment modules comprises a treatment head which is adjusted to a first type of keg fitting, and at least one other of the treatment modules comprises a treatment head which is adjusted to a second type of keg fitting. In this way, each treatment module is adjusted in terms of equipment technology to the different keg types/sizes, and no adjustment work or conversion work is necessary.

Preferably, at least one of the treatment modules further comprises a keg receiver, adjusted to a first keg size or keg type, and at least one other of the treatment modules comprises a keg receiver which is adjusted to a second keg size or keg type. As a result, the treatment module can be optimally adjusted for the handling and treatment of a keg type/keg size.

In an advantageous further embodiment of the invention, at least one treatment module is configured for the cleaning and filling of kegs and has a treatment head for both the interior cleaning as well as for the filling of kegs. As a result, the system is also more flexible than the prior art in respect their distribution to different treatment steps, such as, for example, cleaning or filling. Preferably, several treatment modules, and for best preference all the treatment modules, have the capability of cleaning a keg as well as filling it. In this way, the system is capable of flexibly and individually assigning different treatment work, such as cleaning and filling, to the different treatment modules. By contrast with the prior art, in which the cleaning and filling capacity was determined by the specialized treatment modules, namely filling modules and cleaning modules, in the treatment system according to the invention an entirely flexible allocation of 100% cleaning up to 100% filling is possible, depending on the actuation of the individual modules. It is additionally possible for different products to be filled on different cleaning modules, and for the cleaning time of each keg to be varied according to the degree of dirt contamination.

Preferably, with at least one of the treatment modules and preferably with several or each of the treatment modules, the keg receiver is configured to receive one individual keg. This has the advantage that, in particular with small systems, individual kegs can be filled one behind another with different products. The flexibility of such a system is therefore particularly great since the type of treatment can be changed with each keg. In particular, provision can be made for the respective treatment module to comprise precisely one keg receiver for receiving one individual keg.

Advantageously, the respective treatment module is configured as a “stand alone” module, i.e. as a treatment module which can be operated independently of the other treatment modules of the system. As a result, in respect of the number of the treatment modules, a high degree of flexibility is possible, both with regard to the number of the treatment modules of the system available in total, which can be increased or reduced as desired, as well as with regard to the number of treatment modules which are in operation at a particular point of time.

In one preferred embodiment of the invention, the system comprises a loading device for the delivery and removal of the kegs at the treatment modules. In this way, the loading of the treatment devices can be carried out automatically, which reduces the personnel requirement for the system.

Preferably, the loading device is a loading robot which is controlled by the controller, which can load the different treatment modules with the correct allocated keg types/sizes, and, naturally, can also transport them away. For the correct placement into the treatment modules (as a rule, upside down, i.e. with the fitting pointing downwards), the loading robot can preferably also turn the kegs. The loading robot can be, for example, a jointed arm robot, in particular a five-axis or six-axis folding arm robot. The loading robot is advantageously configured to be moveable in such a way and positioned in such a way that the loading robot can convey the kegs to each of the treatment robots, and/or remove them from each of the treatment modules.

Preferably, the controller is configured such as to calculate the delivery and removal path of each keg, and to carry out the movement of the loading robot in accordance with optimization criteria, among which optimization criteria are also, in particular, path optimization, time optimization, and/or energy optimization, and optimization of the actuation paths of the loading robot. It accordingly serves either to speed up the throughput of the entire treatment system or its energy optimization, which is possible even over shorter path stretches without loss of time.

Instead of the known manner of moving the kegs with transporters past function devices, such as printers for printing a keg, cappers for placing a cap onto a keg fitting, cap removers for taking the cap off a keg fitting, and/or label fitters, the kegs are preferably guided past one or more function devices with the loading robot, wherein these are arranged in such a way that they lie on the travel path of the gripper arm of the loading robot. As a result, separate transporters can be done away with, and the actuation paths of the gripper arm of the actuation robot, which are to be provided for in any event, are additionally used in order to carry out the different functions of the function devices on the keg, without circumventions, and are therefore optimized. In particular, provision can be made for the loading robot to stop briefly at the respective function device, in order for the function device to be able to carry out its intended treatment on a keg.

In one preferred embodiment of the invention, the loading device is a lifting device which can be manually operated, which is equipped with a display unit, wherein the display unit is connected such as to communicate with the controller and is configured such as to display a treatment sequence provided by the controller, according to which the kegs are to be conveyed to the treatment modules and the kegs are to be removed from the treatment modules. In this way, the operator is supported both in terms of power capacity as well as being informed of the successive steps which are to be carried out, which minimizes incorrect actions, in particular with different keg sizes/types. The lifting device can, for example, be pivoted about a vertical fixed-position axis of rotation and can comprise a carrier arm. In order to increase the degrees of freedom, the carrier arm can be multi-part, with arm members being capable of pivoting and/or rotating in relation to one another. A keg holder is then attached to the free end of the carrier arm, which is capable of gripping the keg, for example from a delivery belt, rotating it, and conveying it to a treatment module.

Accordingly, the loading device is preferably configured for the handling of kegs of different sizes and/or different types.

Preferably, the treatment modules are connected to different filling product lines, with which the system can be filled simultaneously with different filling products.

Accordingly, the controller is preferably equipped such as to control the treatment modules in such a way that, with at least one of the treatment modules, a first filling product is filled into a first keg, and with at least another of the treatment modules a second filling product is filled into a second keg, which allows for a time-saving synchronous filling of different products.

Advantageously, each container module has interfaces to at least two filling product lines, which makes it possible for different filling products to be filled on each treatment module. Moreover, the filling product which is to be filled can vary from keg to keg. This additionally increases the flexibility of the system.

In one advantageous further embodiment of the system according to the invention, at least one of the treatment modules comprises, in addition to the treatment head for the treatment, in particular the interior cleaning and filling of the keg, a device for the outside cleaning of the keg. In this way, treatment modules can also undertake tasks of outside cleaning of the kegs, which provides for multiple use capacity and flexibility of the system.

Preferably, in addition to the treatment modules, provided in the treatment system is at least one outside cleaning modules for the outside cleaning of one or more kegs, wherein the loading robot is preferably equipped for the delivery and removal of kegs to/from the outside cleaning module. As a result of this, the functional capacity of the treatment system is extended from interior cleaning and filling also to the outside cleaning of the kegs.

In one advantageous further embodiment of the invention, the treatment system has an identifying device for identifying the keg type and/or the keg size of the respective keg. This makes it possible for the kegs to be delivered, for example by means of a controlled loading device, automatically to the treatment modules, which are adjusted to the corresponding keg type/size. The identifying device can comprise, for example, a camera, which makes the identification of the keg possible by means of image recognition. It can also contain an RFID reader device, which makes an identification of the keg possible by reading out an RFID transponder attached to it. It is of course possible for barcode reader devices and comparable systems to be used, for example based on lasers.

Preferably, the controller is provided with a work plan memory for carrying out filling and/or cleaning commands for different keg sizes and/or keg types and comprises a computer module which is configured such as to assign the filling and/or cleaning commands to the respective treatment modules which are adjusted to the corresponding keg size or the corresponding keg type. In this way the different keg types/sizes can be cleaned and filled in an optimized time or turnover manner.

In one advantageous further embodiment, the system according to the invention has a signal device for guiding the operating personnel with regard to the activities which are to be carried out on the treatment modules. Such a signal device can comprise a display, such as a large size display, one or more light-emitting diodes, and also sound-emitting devices, such as, for example, buzzers, loudspeakers, or the like. The signal device is formed by a server-based application, which is connected to the system. The operator is therefore reliably guided to carry out the steps on the different treatment modules which are specified by the controller.

Preferably, each treatment module comprises an interface with connections to a water line/water vapor line, a prestressing gas line, at least one cleaning medium line to a sterile air and CO2 delivery source, and also the return lines or discharge lines, which standardizes the connections and supports a more rapid and fault-free configuration of the system.

Preferably, at least one of the treatment modules comprises a heat detection device, which is configured such as to measure an outer wall temperature of the keg during the filling and/or cleaning of the keg in the treatment module, in order, for example, to detect the degree of filling of a keg.

Preferably, the keg receiver of the treatment module is configured for the static reception of the keg, both during the cleaning as well as during the filling, which ensures easy handling.

According to the invention, the system for the cleaning and filling of kegs has at least two treatment modules, which in each case comprise a keg receiver for receiving at least one keg, and preferably precisely one keg, during the cleaning and filling, a treatment head both for the filling as well as for the interior cleaning of the keg, and interfaces for at least one cleaning medium line, for a discharge, and for at least one filling product line. According to the invention, the treatment modules, preferably all the treatment modules according to the invention are therefore capable of cleaning as well as filling, wherein a filling is possible preferably also with different filling products. The system is therefore extremely flexible in its arrangement with regard to the different treatment tasks. The treatment system contains at least two treatment modules, preferably between two and eight treatment modules, and is therefore conceived in particular for small or medium-sized beverage fillers for the filling of smaller batches of different filling products.

Moreover, the system contains at least one signal device for the signaling of activities which are to be carried out in connection with the treatment modules, and/or at least one loading robot for delivering and removing the kegs to/from the individual treatment modules, as well as a controller for controlling the signal device/loading robot and the treatment modules.

The signal device can comprise a display, an optical device (such as an LED) and/or a sound-emitting device (such as a loudspeaker, a buzzer, or the like). The signal device serves to summon the operating person to carry out a specific activity on the treatment module or to signal this.

By means of the invention, a plurality of treatment modules can be linked together, which are capable of both filling a keg as well as cleaning at least its interior, with a controller and at least one signal device for signaling activities which are to be carried out in connection with the treatment modules and/or at least one loading robot for delivering and removing the kegs to/from the individual treatment modules.

The signal device is capable of displaying to an operator the activities which are to be carried out or have just been carried out on each treatment module, whether visually or by sound, and therefore inform the operator of the steps to be taken and to guide them in this, or only to bring to their attention the activities which have just been carried out at each treatment module. As an alternative or in addition to the signal device, at least one loading robot can be provided, which is capable of delivering kegs to the individual treatment modules or removing them. The controller can either be provided centrally or in the form of centralized control modules, for example for the individual treatment modules, for the signal device, and/or for the loading robot, which communicate with one another. The controller is preferably a common controller, which is connected such as to communicate with several, and preferably all, of the treatment modules, as well as with the signal device and/or the loading robot, and is configured so as to control the units connected to it, in particular in a manner matched to one another, and/or process-optimized.

The arrangement of the treatment modules relative to the loading robot can be different. The treatment modules can therefore be arranged, for example, in a linear manner one behind another, and/or above one another. As an alternative or in addition, it is possible for the treatment modules to be arranged in a circular manner around a loading robot. The loading robot can be configured as a conventional industrial robot with a handling arm for gripping the keg, which is capable conveying the keg from a delivery region, for example a conveyor belt, into the receiver of the treatment module, and, after the treatment of the keg has been carried out, transferring it again from the treatment module onto a discharge region, for example a further discharge conveyor belt. With a linear arrangement of the treatment modules, it is also possible for the robot to be moved on a rail or by means of a travel frame. The modules can, for example, be coupled by means of common system parts such as a media supply or tank systems.

If it is intended that kegs with different fittings or different sizes are to be used, they can preferably be treated on different treatment modules which are suitable for the treatment of the different keg sizes and/or fittings, or kegs with fittings made of different materials, but all of which comprise the treatment head which allows for both internal cleaning as well as filling of the corresponding keg. Such a treatment system is also easily extendible, since by way of standardized interfaces an easy connection can be established to filling product lines, prestressing gas lines, water lines or water vapor lines, and a cleaning medium line, and to corresponding return or discharge lines. In principle, the modules referred to, thanks to the use of suitable “format parts”, are capable of treating all possible keg sizes, materials, and fitting types.

With regard to control technology, in this situation only the new treatment module and its precise position would have to be updated into the control data, and in this way the treatment capacity of the treatment system could be easily extended. This new inventive concept of a modular treatment system with treatment modules, which comprise a combined treatment function for both the cleaning as well as for filling, therefore allows for the production of treatment systems of the most widely differing sizes, depending on the number of modules selected, an entirely individualized control of the cleaning and filling processes, with cleaning cycles which can be individually determined depending on the degree of dirt contamination of the kegs which are to be filled, and even for the simultaneous filling of kegs with different filling products in the different treatment modules at the same time, while, for example, the kegs are simultaneously being cleaned in other treatment modules. The treatment system according to the invention is therefore particularly well-suited for small beverage manufacturers, such as, for example, small and medium-sized fillers, in particular breweries which offer a large number of different beer varieties.

In one advantageous further embodiment of the invention, each treatment module has interfaces to a water line/water vapor line, a prestressing gas line, and at least one cleaning medium line, and to the corresponding return or discharge lines. In this way, all conventional cleaning media can be delivered which are necessary for a thorough interior cleaning of the keg.

Preferably, the loading robot or a lifting device or lifting aid contains a gripper arm which can be moved with several degrees of freedom, for gripping the kegs. This has the advantage that both different keg sizes can be gripped and arranged in treatment modules which are further away, and that, on the other hand, the loading and removal of the kegs, such as the travel path and/or the time, can be optimized in a simple manner by the corresponding controller of the multiple movable gripper arm.

Preferably, at least one of the treatment modules, in addition to the treatment head for the filling and interior cleaning of the kegs, has a device for the outside cleaning of the kegs. The flexibility of a treatment module is thereby extended, from the two different types of treatment, filling and interior cleaning, to the three treatment types of filling, interior cleaning, and outside cleaning, which again increases the flexibility of the system as a whole, and makes the provision of separate outside cleaning modules superfluous. The treatment modules in the treatment system can therefore preferably all be configured as identical.

As an alternative or in addition, it is possible, in addition to the treatment modules, for at least one specialized outside cleaning module to be provided, which is configured only for the outside cleaning of one or more kegs. The outside cleaning module is of course arranged in the access region of the loading robot for the delivery and discharge of the kegs to/from the outside cleaning module. The loading robot can therefore, as an alternative, load a treatment module for the filling and interior cleaning, or an outside cleaning module for the outside cleaning of the keg, wherein the controller can control these container treatment types in an optimum manner. The outside cleaning process can additionally be displayed by the signal device to an operator if no loading robot is being used.

In one advantageous further embodiment of the invention, at least two of the treatment modules are attached, in particular by way of a supply interface, to a common media supply, for example to a common filling product supply and/or to a common filling product supply. This can simplify the infrastructure effort for the supply of the treatment modules, namely the feed of the filling product and the feed of the different cleaning media. The kegs and the treatment modules are then connected to these common supply lines, preferably by way of standardized supply interfaces, such as, for example, connection flanges. This allows for a rapid and standardized replacement of a cleaning module in the event of wear or a repair.

Preferably, the controller has at least one data memory for individual date of the keg. This data can be transferred to the controller by means of the treatment command. As an alternative, this data can be read out from a data carrier of the keg by means of a reader device of the system. The controller is configured such as to control the duration of a cleaning cycle and possibly of a pre-cleaning cycle in a treatment module as a dependency of the individual data. The data can also be read in from the information carriers located on the kegs, such as barcodes or RFID tags, on which information carriers information is then contained regarding the location, time of use, and/or storage, regarding the filled product etc., which is suitable for the assessment with regard to the cleaning effort and expenditure to be anticipated.

This has the advantage that the cleaning cycle can be selected to be as long as is appropriate for the degree of dirt contamination of a keg, which can be determined directly or indirectly in the manner described heretofore by way of the information which can be read out at the keg, such as the customer, the delivery location, the filling product, the cycle time, etc. As a result, with different degrees of dirt contamination, it is always possible for a complete cleaning of the interior to always be carried out, but also rapidly and efficiently. Specifically, by determining the degree of dirt contamination and the correspondingly adjusted performance of the cleaning cycle, the duration of the cleaning cycle can also be reduced to the amount which is actually necessary. As a result, there is no dead time incurred in the treatment throughput of the system due to an unnecessarily long cleaning of kegs.

In one advantageous further embodiment of the invention, at least one of the treatment modules contains an outside wall thermometer or a thermal imaging camera for the keg, which is configured such as to measure an outside wall temperature of the keg during the filling and/or cleaning of the keg in the treatment module. By means of this measurement, the treatment step which is currently being carried out, such as the cleaning or filling, can be verified on the basis of the temperature and monitored and controlled accordingly.

Preferably, the keg receiver of the treatment module is configured for the static reception of the keg both during the cleaning as well as during the filling. It is advantageous, with regard to the time spent and also the effort of the action by the loading robot, if a position of the keg which has once been adopted in the receiver of the treatment module is not changed between the different treatment types of filling and interior cleaning. This means that the keg is cleaned and also filled in the same position. This allows for a more rapid throughput of kegs which are to be treated in the treatment system, and also reduces the handling effort with the kegs which would otherwise have been necessary for the keg to be shunted between the different types of treatment, to say nothing of less mechanical wear and tear of the loading robot with less handling effort. In addition to this, the mechanical elements of the system are subject to less stress. Due to the fact that the spring package of the keg fitting is only actuated once for the interior cleaning and for filling, i.e. opened once and closed again once, the mechanical system of the keg fitting, in particular the spring mechanics, are actuated less often and are therefore subjected to less stress.

In this situation, in particular the computer module of the controller is configured such as to control the treatment modules and the signal device/the loading robot in such a way that the order processing is either time-optimized, optimized with regard to filling and/or cleaning capacity or runs in an optimized manner in respect of the actuation paths of the robots. These optimization criteria can of course also be taken into consideration in any manner desired, for example by a corresponding costs function.

Preferably, the controller is configured such as to fill at least one of the treatment modules with a first filling product and at least one other of the treatment modules with a second filling product, such that different filling products can be filled in the treatment system simultaneously, which in turn optimizes the flexibility of the treatment system, in particular for smaller filling operations or for the filling of smaller batches.

Preferably, the treatment modules are configured for the treatment of different kegs, wherein at least one of the treatment modules is configured for the treatment of kegs of a first type, and at least one other of the treatment modules is configured for the treatment of kegs of a second type. In this way, not only can different filling products be treated in the treatment system, but also different keg sizes or keg shapes.

In the treatment modules and by means of the loading robot, if required, further treatment steps can be carried out, such as drawing off a cap from the fitting of the keg before the treatment or fitting one after the treatment, providing a label or direct ink-jet printing onto the outer wall of the keg, turning the keg, in particular by means of the loading robot, and the screening out of unsatisfactory kegs by means of a lock extraction system (for example, kegs which are defective or so dirt contaminated that they can no longer be cleaned). If the kegs are delivered the wrong way round when provided, there is the possibility of programming an automated turning process in the loading robot. As an alternative, the kegs can also be turned by the positioning of the treatment module.

The cleaning can further comprise an interior cleaning and outside cleaning. For the interior cleaning of the keg, a preliminary cleaning can also be provided without additional expenditure on technical apparatus, in which, for example, a keg is filled in particular with alkali by the treatment module and then placed onto a precleaning location, in which the alkali can take effect for a time without a treatment module being occupied during this period. This also serves to optimize the treatment processes. The keg can be brought from the treatment module to the precleaning location either by the loading robot or by an operator, and, after the period of taking effect, it can be transported back again from the treatment module to the precleaning location. This can be done under the guidance of the signal device. After the precleaning the actual interior cleaning of the keg can be carried out, and, following this, the filling in the treatment module.

It is obvious to the person skilled in the art that the embodiments described heretofore and hereinafter can be combined with one another in any desired manner.

### BRIEF DESCRIPTION OF THE DRAWINGS

An exemplary embodiment of the invention is described hereinafter on the basis of the schematic drawings in which:

FIG. 1 is a view from above a keg-treatment system,

FIG. 2 shows a cross-sectional view along the dashed line in FIG. 1,

FIG. 3 shows a treatment module with an additional outside cleaning device for the keg, and

FIG. 4 shows an exemplary treatment head for the interior cleaning and filling of a keg.

### DETAILED DESCRIPTION

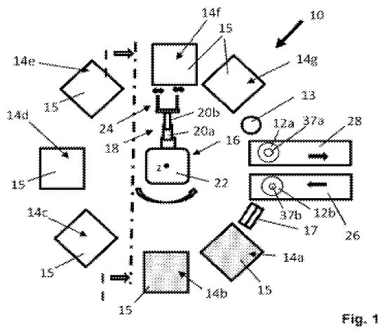

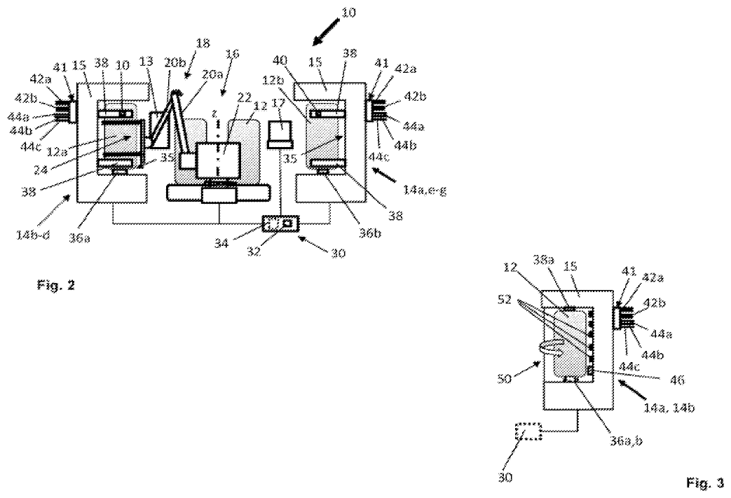

FIGS. 1 and 2 show a keg-treatment system 10 for the cleaning and filling of first kegs 12a and second kegs 12b. The keg-treatment system 10 comprises seven container treatment modules 14a-14g that are arranged in a circle around a loading robot 16. The first kegs 12a and the second kegs 12b are of different types. In particular, the first and second kegs 12a, 12b differ in one or more of: their materials, dimensions, volumes, and fittings. Accordingly, the apparatus described herein is configured to treat multiple instances of first and second kegs 12a, 12b.

Among the treatment modules are first treatment modules 14b-14d and second treatment modules 14a, 14e-14g. Each of the first treatment modules 14b-14d is equipped with a first treatment head 36a. This first treatment head 36a is adjusted to engage a first fitting 37a, which is that of the first keg 12a. Similarly, the second treatment modules 14a, 14e-14g are equipped with a second treatment-head 36b, which is configured to engage a second fitting 37b, which is that of the second keg 12b. In a preferred embodiment, each treatment module 14a-14g has a combined cleaning-and-filling head 36a, 36b that is capable of both filling respective first and second kegs 12a, 12b and cleaning their respective interiors.

The loading robot 16 comprises a base body 22 that rotates about a vertical axis z. The base body 22 carries a gripper arm 18. The gripper arm 18 moves with several degrees of freedom.

The gripper arm 18 comprises a first section 20a and a second section 20b that are joined to each other by a joint. The first section 20a attaches the gripper arm 18 to the robot's base body 22. A free end of the second section 20b carries a gripper 24 that connects to the second arm section 20b via a joint. This gripper 24 grips an empty keg 12a, 12b from a delivery belt 26 and passes it to a an appropriate one of the treatment modules 14a-14g. The gripper 24 also removes treated and/or filled kegs 12a, 12b from treatment modules 14a-14g and delivers them to a discharge belt 28 from which the treated and/or filled kegs 12a, 12b are transported away.

As an alternative or in addition to the loading robot 16, a signal device 17 provides a representation of which treatment process is to be executed or which treatment process is currently being executed at the first treatment modules 14a-14g. In those embodiments that lack a loading robot 16, the display 17 guides an operator in ensuring an optimum cleaning and filling at the treatment modules 14a-14g. In a preferred embodiment, the signal device 17 takes the form of a display.

One or more function devices 13 are arranged along the gripper arm's travel path. Examples of a function device 13 include a printer, a capper, a cap remover, a label fitter, or the like. This makes it possible to integrate additional treatment steps without having to make any major changes to the gripper arm's travel path. Examples of treatment steps that can be integrated include application of a label, printing on the keg, fitting a cap onto the keg's fitting, and removing a cap from the keg's fitting.

In some embodiments, a single controller 30 connects to the display 17, to the loading robot 16, and to every treatment module 14a-14g. Other embodiments implement a more decentralized system in which plural controllers are networked together. A suitable controller 30 is one that relies on a microprocessor.

The controller 30 contains a working-plan memory 32 that stores cleaning and filling commands that are to be executed by the treatment system 10 for the different kegs 12a, 12b and information about the assignment of the first and second kegs 12a, 12b to respective first and second treatment modules 14b-14d, 14a, 14e-14f. The controller 30 includes a computer module 34 that has been configured, based on the content of the working-plan memory 32, to provide optimal control over filling commands that are in progress, the display 17, the loading robot 16, and each of the treatment modules 14a-14g.

Some embodiments include exterior-treatment modules 14a, 14b for cleaning kegs' exteriors, i.e., the kegs' outer walls. In a preferred embodiment, the exterior-treatment modules 14a, 14b are arranged so that the kegs 12a, 12b encounter upon leaving the delivery belt 26. Thus, in FIG. 1, the exterior-treatment modules 14a, 14b are shown in in the clockwise direction following the delivery belt 26. In the illustrated embodiment, a first exterior-treatment module 14a cleans the first keg 12a and has a first treatment head 36a, which is configured to engage the first fitting 37a. The second exterior-treatment module 14b cleans the second keg 12b and therefore has a second treatment head 36b, which is configured to engage the second fitting 37b.

The controller 30 causes both the first and second kegs 12a, 12b to be cleaned and filled in an optimized manner in conjunction with the first and second assigned treatment modules 14b-14d, 14a, 14e-14g, and in particular, to minimize dead-time during treatment and energy consumption during treatment.

In some embodiments, only the first two treatment modules 14a, 14b are equipped with external cleaning stations. The remaining treatment modules 14c-14g only execute internal cleaning and filling using their respective cleaning-and-filing heads 36. In this case, the first two treatment modules 14a, 14b are configured to clean both types of keg 12a, 12b. Since no interaction with a keg fitting is required, the first two treatment modules 14a, 14b do not require treatment heads.

The loading robot 16 rotates about a central axis z that is located in the center of a circle defined by the treatment modules 14a-14g. This configuration is particularly advantageous because the distances between the loading robot 16 and all the treatment modules 14a-14g are identical. This simplifies the calculation and optimization of the delivery and discharge paths.

Referring to FIG. 2, each treatment module 14a-g has a receiver 35 and a holder 38 configured for one of the two types of keg 12a, 12b. In some embodiments, the holder 38 holds a temperature sensor 40. Among these embodiments are those in which the temperature sensor 40 is located separately from the holder 38, as a result of which its position is freely selectable. In still other embodiments, several temperature sensors 40 arranged at various locations detect the temperature and temperature curves. In some embodiments, the temperature sensor 40 includes a thermal-imaging camera.

An alternative embodiment of a holder 39a for holding the keg 12a, 12b in the treatment module 14a-14g is one that engages the keg 12a, 12b from the top, as shown in FIG. 3. In this embodiment, the keg 12a, 12b is held upside-down in its cleaning-and-filling position in the treatment module's receiver 35. In this orientation, the keg's fitting connects to the combined cleaning/filling head 36 from below.

Each treatment module 14a-14g is connected to its own supply interface 41. The supply interface 41 includes several filling product connections 42a, 42b to several product lines. This makes it possible to fill with different filling products simultaneously. In addition, after filling a keg 12a, 12b, it is possible to change the filling product delivered to the treatment module 14a-14g.

The supply interface 41 also connects each treatment module 14a-14g to media lines. In particular, the supply interface 41 includes a water connection 44a, a water-vapor connection 44b, and a cleaning-medium connection 44c. Other embodiments of the supply interface 41 include one or more of a prestressing gas line, a carbon-dioxide line, and a wastewater line.

Having a supply interface 41 at each treatment module 14a-14g makes it possible to simultaneously carry out different treatment steps simultaneously in the container treatment system 10. Examples of treatment steps that can be carried out simultaneously include cleaning and filling with a first filling-product, and filling with a second filling-product. In even a small system, such as one with only two treatment modules, this confers considerable flexibility. The ability to control different treatment processes, such as cleaning the keg's interior and filling it with different filling products, and to do so using filling commands present in the work plan memory 32, makes it possible to economically provide customized treatment for batches having very few kegs, right down to a single keg. This system is therefore well-suited for a dynamic treatment of kegs 12a, 12b in small and medium-sized filling systems.

In some embodiments, the first two container-treatment modules 14a, 14b include an exterior-cleaning system for cleaning the keg's exterior, as is shown in FIG. 3. As a result, it is useful to enclose the keg receivers 35 of the first two container-treatment modules 14a, 14b with a housing 50 or cover, such as one made of glass, plexiglass, metal, or stainless steel. This makes it possible avoid wetting the surroundings while spraying the keg's outer wall with a high-pressure jet and/or a pressurized steam jet from a spray nozzle 52.

A base holder 38a holds the keg 12a, 12b so that the keg 12a, 12b can be rotated from above. This makes it possible to effectively clean all sides of the keg's outer wall. The controller 30 moves the housing 50 between a release position and a working position and also actuates the spray jets 52.

A treatment module can be configured to carry out only external cleaning, only internal treatment, or both. In some embodiments, the first two treatment modules 14a, 14b are configured to carry out both external and internal cleaning. On others, the first two treatment modules 14a, 14b are configured only for exterior cleaning and internal cleaning takes place at the subsequent treatment modules 14c-14g.

In some cases, a keg 12a, 12b includes a machine-readable data carrier that carries data. It is therefore useful to provide a reader 46 to read this data. In some cases, each treatment module 14a-14g has its own reader 46. In other cases, a single reader 46 that provides data as needed to the controller 30, which then controls the treatment modules based on that data.

A keg's data enables the controller 30 to learn the keg's filling location and the filling product that the keg is to be filled with. It is also possible to infer, directly or indirectly from its degree of dirt contamination. In some embodiments, the controller 30 includes a memory for storing data about the keg 12a, 12b and making it available for reference purposes. Examples of data include information about which customer last handled the keg, the keg's empty weight, the product that last filled the keg, how long the keg was with the customer, and how long the keg has been in transit or stored. This data permits the controller 30 to draw conclusions concerning the degree of contamination and to use those conclusions to adjust an individual cleaning time for each keg 12a, 12b.

In some embodiments, there exist additional sensors for use in estimating the extent of a keg's contamination by, for example, dirt. Examples of such sensors include a weight sensor, which weighs the keg 12a, 12b, or a vibration sensor, from which it is possible to infer an extent of contamination based on the keg's vibrations. Based on data from these sensors, the controller 30 is able to adjust the duration of the cleaning process individually for each keg 12a, 12b.

The controller 30 thus cooperates with the reader 46 to adapt its cleaning-and-filling commands to carry out optimal cleaning and treatment on a keg-by-keg basis, essentially implementing bespoke cleaning of kegs based on dynamically collected data on each keg 12a, 12b. This is different from conventional mass production processes in which each keg is treated the same way regardless of the keg's condition. As a result, kegs that are already fairly clean can be treated for shorter periods and only those kegs that require extensive cleaning will be cleaned for longer periods. This avoids the “one-size-fits-all” approach of conventional mass production systems. The result is of the interaction of the controller 30 and the reader 46 is a highly effective and rapid container treatment that carries out external cleaning, interior cleaning, and filling for small and medium-sized filling systems.

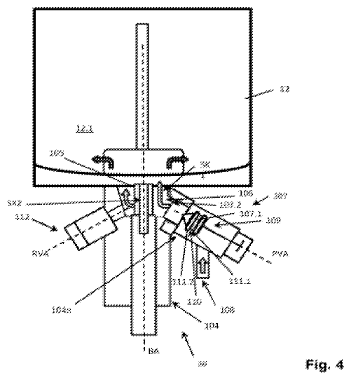

FIG. 4 shows a typical treatment head 36 of the type used by at least one of the treatment modules 14a-g. The treatment head 36 is a multifunctional treatment head 36 for the interior cleaning and filling of kegs 12a, 12b.

The treatment head 36 comprises a treatment-head housing 104 that comprises a plunger 105. The plunger 105 is received at least partially in a cavity space of the treatment-head housing 104 and is held in a movable manner in the axial direction of a treatment-head axis BA in the treatment-head housing 104. The plunger 105 moves to open the keg fitting of the keg 12a, 12b which is to be treated and which is arranged in a sealing position at the treatment head 36.

The cavity space in the treatment head housing 104 forms a fluid space 106 and flow paths SK1, SK2, which communicate in a controllable manner with the fluid space 106 and which, with the keg fitting open of a keg 12a, 12b arranged in a sealing position at the treatment head 36, can be connected in a controlled manner with the keg's interior 12.1 of the keg 12a, 12b.

The keg's interior 12.1 can be filled with the filling product by way of the first flow path SK1. The second flow path SK2 provides a controllable discharge of at least one treatment medium out of the keg's interior 12.1, 12b, and/or a controllable supply of at least one treatment medium into the keg's interior 12.1. The second flow path SK2 can extend at least partially through the plunger 105.

The treatment head 36 includes a product valve 107 and a return valve 112, both of which are assigned to the fluid space 106. The product valve 107 is for controlled supply of a filling product from a product feed 108 that connects to the product valve 107. The product valve 107 and the return valve 112 extend along a product valve axis PVA and a return valve axis RVA, respectively. The product valve 107 and the return valve 112 connect to a respective valve housing section 104a at a transition section of the treatment head housing 104. In some embodiments, the valve housing section 104a is an integral part of the treatment head housing 104 and is thus formed as one piece with it.

The product valve 107 includes a valve body 107.1 that is at least partially received in the valve housing section 104a or that projects into the valve housing section 104a. An actuator moves the valve body 107.1 along the product valve axis PVA. The valve body 107.1 seals against a valve seat 107.2 in the valve housing section 104a when in the product valve 107 is in its closed position.

In its open position, as shown in FIG. 4, the valve body 107.1 is separated from the valve seat 107.2, thus establishing a flow path for the filling product between the filling product feed 108 and the fluid space 106 via the first flow path SK1. The controller 30 controls and monitors the product valve 107 and the return valve 112. In particular, the controller 30 controls and monitors the valve positions and the switching of the product valve 107 and the return valve 112.

In a preferred embodiment, the treatment head 36 is a multifunctional treatment head in which the product valve 107 comprises a multiple sealing arrangement 109 that provides plural seals between the filling product feed 108 and the fluid space 106, thereby promoting a secure separation between the filling product and any cleaning media. In the illustrated embodiment, the multiple sealing arrangement 109 includes a double-seat valve having first and second sealing elements 111.1, 111.2 that form a leakage space 110, that can be flushed. In its closed position, the product valve 107 forms a separated intermediate space between the fluid space 106 and the filling product feed 108. This causes a reliable separation between the filling product feed 108 and the fluid space 106.

A cleaning and filling process begins with introduction of an empty keg 12 into the treatment module 14a-g and the positioning of the keg 12a, 12b so that it moves with its fitting pressed against the treatment head 36, thus forming a seal therebetween.

The interior cleaning begins with the plunger 105 opening the keg fitting. This is followed by one or more sequential cleaning steps, each of which includes the introduction of a cleaning medium into the keg's interior through the treatment head 36 and the discharge of that medium through the return valve 112. The product valve 107 remains connected to the product feed 108 during the entire treatment period. However, the product valve 107 remains in its closed position so that the leakage space is between the fluid space 106 and the filling product feed 108 as a result of the double seal formed by the multiple sealing arrangement 109.

Once the keg's interior has been cleaned, the product valve 107 moves into an intermediate position for flushing the leakage space 110. A flushing device at the leakage space 110, which is not shown, permits controlled discharge to the outside. This results in a thoroughly flushed and emptied leakage space 110. With the leakage space 110 having been thoroughly cleaned, the controller 30 opens the product valve 107 to introduce filling product into the keg and closes it once the desired filling level has been reached.

It is clear to the person skilled in the art that the exemplary embodiment represented is not to be understood as restrictive, but that the invention can be put into effect within the scope of protection of the appended claims.

1-19. (canceled)

20. An apparatus for treating kegs, said apparatus comprising treatment modules, each of which comprises a keg receiver for receiving at least one keg during the treatment, a treatment head for treating a keg mounted thereto, an interface having connections for receiving filling product for the keg, receiving cleaning medium for the keg, and discharging cleaning medium from the keg, and a controller for controlling said treatment modules, wherein said kegs comprise first kegs and second kegs, said first kegs and said second kegs differing from each other in at least one of type and size, wherein said treatment modules comprise first treatment modules and second treatment modules, wherein said first treatment modules are configured to treat said first kegs and said second treatment modules are configured to treat said second kegs.

21. The apparatus of claim 20, wherein each of said treatment modules comprises one of a first treatment head and a second treatment head, wherein said first treatment head is configured to engage a first type of keg fitting and said second treatment is configured to engage a second type of keg fitting.

22. The apparatus of claim 20, wherein said first treatment module comprises a keg receiver adjusted to a first keg size and said second treatment module comprises a keg receiver adjusted to a second keg size.

23. The apparatus of claim 20, further comprising a treatment module that comprises a treatment head for both interior cleaning and filing of a keg.

24. The apparatus of claim 20, at least one of said treatment modules comprises a keg receiver that receives a single keg.

25. The apparatus of claim 20, further comprising a loading device for delivering kegs to said treatment modules and for receiving kegs discharged from said treatment modules.

26. The apparatus of claim 20, further comprising a controller and a loading robot controlled by said controller, wherein said loading robot is configured to deliver kegs to said treatment modules and to receive kegs discharged from said treatment modules.

27. The apparatus of claim 20, further comprising a controller that is configured to control said treatment modules and to control a loading robot in such a ways as to cause individual treatment modules in a way that optimizes at least one of: time for treatment, filling and/or cleaning capacity, energy usage, and actuation paths of said loading robot.

28. The apparatus of claim 20, further comprising a function device and loading robot having a gripper arm, wherein said function device is arranged along a travel path of said gripper arm, and wherein said function device is selected from the group consisting of a printer for printing on a keg, a capper for capping a keg fitting, a cap remover for removing a cap from a keg fitting, and a label fitter.

29. The apparatus of claim 20, further comprising a manually-operable lifting device for delivering kegs to said treatment modules and for receiving kegs discharged from said treatment modules, wherein said lifting device comprises a display that is in communication with a controller, wherein said display receives a processing sequence from said controller, wherein said processing sequence comprises information indicative of which kegs are to be delivered to which treatment modules and which kegs are to be discharged from which treatment modules.

30. The apparatus of claim 20, further comprising a loading device that is configured for handling said first kegs and said second kegs for delivery of said first kegs to said first treatment modules, for delivery of said second kegs to said second treatment modules, and for receiving kegs discharged from said first and second treatment modules.

31. The apparatus of claim 20, wherein said first treatment modules and said second treatment modules are connected to different filling-product lines.

32. The apparatus of claim 20, wherein each of said kegs comprises an interior and an exterior and wherein at least one of said treatment modules is configured to clean both said keg's interior and said keg's exterior.

33. The apparatus of claim 20, further comprising an exterior-cleaning module for cleaning an exterior surface of said kegs.

34. The apparatus of claim 20, further comprising a machine-readable data carrier that carries data that identifies at least one of a type and a size of a keg.

35. The system of claim 20, further comprising a controller that comprises a computer and a memory, wherein aid memory is a work-plan memory for storing filling commands and cleaning commands that are to be carried out for said first and second kegs, wherein said computer is configured to assign filling commands and cleaning commands to said treatment modules based on which said first kegs and said second kegs are to be treated.

36. The apparatus of claim 20, further comprising a controller that controls said treatment modules in such a way that said first kegs are filled with a first product and said second kegs are filled with a second product.

37. The apparatus of claim 20, further comprising a signal device for providing guidance to operating personnel by displaying information on activities to be carried out at each of said treatment modules.

38. The apparatus of claim 20, further comprising a signal device for providing guidance to operating personnel by emitting sounds that communicate information on activities to be carried out at each of said treatment modules.

39. The apparatus of claim 20, further comprising a reader to read data from data carries on said kegs.
